(19) United States
(12) Patent Application Publication
(10) Pub. No.: US 2006/0286200 A1
(43) Pub. Date: Dec. 21, 2006

(54) Confections containing flavor delivery systems

(76) Inventors: Armando J. Castro, Westchester, IL (US); David L. Witkewitz, Bridgeview, IL (US); Barbara Z. Stawski, Forest Park, IL (US)

Correspondence Address: WRIGLEY & DREYFUS 28455;BRINKS HOFER GILSON & LIONE, P.O. BOX 10395, CHICAGO, IL, 60610, US

(21) Appl. No.: 11/402,227

(22) Filed: Apr. 11, 2006

Related U.S. Application Data
(60) Provisional application No. 60/672,912, filed on Apr. 18, 2005.

(51) Int. Cl. A23G 4/00

(52) U.S. Cl. 426/3

(57) ABSTRACT

A method of producing a candy product includes providing a core including a first flavoring agent. The core is coated with a first layer to form a first coated product. The first layer may be a hydrophobic layer or a hydrophilic layer. The first coated product is coated with a second layer including a second flavoring agent to form an encapsulated particle. The second layer may be a hydrophobic layer or a hydrophilic layer. A plurality of the encapsulated particles is mixed with a base material to form a candy composition. The candy composition is formed into a candy product.

### RELATED APPLICATIONS

This application claims the benefit of U.S. Provisional Patent Application No. 60/672,912, filed Apr. 18, 2005, the entire disclosure of which is hereby incorporated herein by reference.

### BACKGROUND

Various confections typically provide a sustained release of flavor. However, in some cases it may be desirable to provide an initial burst of flavor, followed by second burst of a same or different flavor. Also, consumers of chewy candy gain satisfaction from the action of long mastication and enjoy the continuous flavor that can be derived during the process. For example, consumers like candy that releases flavor over long periods of chew. Thus, it would be desirable to have a flavor delivery system that provides a delayed release of a flavor or multiple bursts of flavors in a confectionery product.

### BRIEF SUMMARY

It has been found that by encapsulating a flavoring agent, a candy product can be formed that provides a delayed release of the flavoring agent when the candy is chewed by a consumer. The types and levels of encapsulating coatings can be chosen to control the release of the flavoring agent.

In one aspect, a method of producing a candy product includes providing a core including a first flavoring agent. The core is coated with a first layer to form a first coated product. The first layer may be a hydrophobic layer or a hydrophilic layer. The first coated product is coated with a second layer including a second flavoring agent to form an encapsulated particle. The second layer may be a hydrophobic layer or a hydrophilic layer. A plurality of the encapsulated particles is mixed with a base material to form a candy composition. The candy composition is formed into a candy product.

In another aspect, a candy product includes a plurality of encapsulated particles. The encapsulated particles include a core including a first flavoring agent. A first layer surrounds the core and includes a hydrophobic material. A second layer surrounds the first layer and includes a second flavoring agent and a hydrophilic material. The candy provides a first wave of flavor from the second flavoring agent followed by a second wave of flavor from the first flavoring agent.

The foregoing and other features and advantages of the present invention will become apparent from the following detailed description of the preferred embodiments, when read in conjunction with the accompanying examples.

### BRIEF DESCRIPTION OF THE DRAWINGS

FIG. 1 is a process diagram of a preferred embodiment of a method of the present invention.

### DETAILED DESCRIPTION OF THE DRAWINGS AND PREFERRED EMBODIMENTS

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. The terms “candy” and “confection” are used interchangeably herein.

In one aspect, the present invention is directed to candies with flavor delivery systems. In particular, it provides candies with multiple flavor waves and methods of making them. By multiple flavor waves is meant that the candy provides an initial flavor sensation, which reaches a peak and tapers off, followed by a second flavor sensation. A third or even further flavor waves may follow. The flavor waves may be the same flavor or different flavors. The flavor waves may include not only flavors, but sweeteners, cooling agents, sensates, and the like. The second flavor wave preferably occurs after about 1 to 8 minutes of chewing, most preferably after about 3 minutes of chewing.

In one embodiment, the candy includes an encapsulated flavoring agent. The encapsulated flavoring agent includes a plurality of encapsulated particles. Each encapsulated particle includes a core with a first flavoring agent, a first layer surrounding the core, and a second layer surrounding the first layer and including a second flavoring agent. In other embodiment, further layers may be applied, with or without additional flavoring agents.

In another embodiment, the candy includes a plurality of two types of encapsulated particles. The first type of encapsulated particle includes a first flavoring agent and a first coating. The second type of encapsulated particle includes a second flavoring agent and a second coating. The second coating may be either thicker than the first coating, or of a different material, so that the first flavoring agent is released first as the candy is chewed, followed afterwards by the second flavoring agent. The release time of the first type of encapsulated particle is between about 1 minute and about 8 minutes, preferably about 3 minutes.

The flavor delivery system of the present invention may be used in any sort of candy product. It is particularly preferred for use in a chewy candy product. The release times of flavoring agents as the candy is sucked and/or chewed can be adjusted by using different coating materials and different thicknesses of the layers of coatings. Different coating materials can have different solubilities, allowing control of the time for dissolving in the mouth as the base material is consumed. Coating layers can be chosen such that some require more chew and shear to break them, thus releasing the flavoring agents. Additionally, flavoring agents could be added to the candy product in layers or the candy product could contain layers with different flavoring agents in each layer. The layers could have a range of textures, chew, and solubility, thus releasing the flavors in different orders.

The term “flavoring agent” is meant to include flavors, sweeteners, cooling agents, sensates, and the like. The flavors used in the various layers of the candy product may include cooling agents such as menthol as well as essential oils, synthetic flavors, or mixtures including but not limited to oils derived from plants and fruits such as citrus oils, fruit essences, peppermint oil, spearmint oil, clove oil, oil of wintergreen, anise and the like. Artificial flavoring components are also contemplated for use in the candy product. Those skilled in the art will recognize that natural and artificial flavoring agents may be combined in any sensorially acceptable blend. All such flavors and flavor blends are contemplated by the present invention.

Physiological cooling agents may also be used. A variety of physiological cooling agents are discussed in U.S. Pat. No. 6,627,233, the contents of which are hereby incorporated by reference herein. Preferred physiological cooling agents are substituted p-menthane carboxamides, such as n-ethyl-p-menthane-3-carboxamide (called WS-3); acyclic carboxamides, such as N-2,3-trimethyl-2-isopropyl butanamide (called WS-23); menthone glycerol ketal; menthyl lactate; menthyl succinate; and 3-1-menthoxypropane-1,2-diol.

Sensates may also be used as flavoring agents and include cooling agents, and pungent, hot, and tingling flavors.

In one embodiment, the encapsulated particle includes a core with a first flavoring agent. The core is surrounded by a first layer. The first layer preferably includes a hydrophobic material. The first layer allows the first flavoring agent to have a delayed introduction into the user's senses. The first layer is coated with a second layer including a second flavoring agent. The second layer is preferably hydrophilic and provides an immediate flavor sensation in the mouth of a user. Although a preferred embodiment includes a first hydrophobic layer and a second hydrophilic layer, greater numbers of layers are possible.

It will be apparent that more than one flavoring agent may be used in the various layers of the encapsulated particle. In particular, a flavor or physiological cooling agent is preferably combined with a sweetener.

The flavoring core of the encapsulated material may be prepared by any suitable method. In one embodiment, the core is between about 10 microns and about 100 microns in diameter. In another embodiment, the core is between about 0.2 microns and about 10 microns in diameter. In another embodiment, the core is between about 100 microns and about 300 microns in diameter. When multiple coatings are required, it is desirable to have as small of a flavoring core as possible. Small particles allow a fluid bed coater to coat multiple layers upon the flavoring core. In one embodiment, the encapsulated particle includes up to 6 layers of coating.

The first layer surrounding the core is preferably made from a hydrophobic or low water-solubility material. Such hydrophobic or low water-solubility compositions include acrylic polymers and copolymers, carboxyvinyl polymers, cellulose acetate phthalate, ethyl cellulose, methyl cellulose, hydroxymethylcellulose phthalate, polyamides, polystyrene, polyvinyl acetate, polyvinyl acetate phthalate, polyvinylpyrrolidone and waxes. Two food-grade coating materials that are good film formers but not water soluble are shellac and zein. The material for the first layer is preferably selected from zein, wax, and polyvinyl acetate. The hydrophobic material preferably imparts elasticity to the encapsulated particle so that it can withstand mastication for a sufficient period of time to provide a second flavor wave.

Zein is normally thought to be relatively insoluble in water, except at high pH. However, it has been found that by reducing the zein particle size to a particle size of less than about 150 micron, the solubility increases dramatically. This reduced particle size allows a high concentration aqueous solution to be prepared which has greater film formation properties during encapsulation. The film coats aspartame, other high intensity sweeteners, or other flavoring agents to reduce their water solubility. The encapsulation extends the sweetener and flavor duration in the chewy candy. Zein can be milled to the smaller particle size with a Fitzmill Comminutor.

In one embodiment, the second layer includes a hydrophilic or water soluble material. Materials which are water soluble include agar; alginates; carrageenan; a wide range of cellulose derivatives like sodium hydroxymethyl cellulose, and hydroxypropylmethyl cellulose; dextrin; gelatin; gums such as acacia, guar, locus bean, and xanthan; pectin; proteins such as soybean, whey, gluten, and zein; and modified starches. Other encapsulants like acacia or maltodextrin can also encapsulate a flavoring agent and give a fast release rate of a flavoring agent in candy. Preferred materials include acacia gum, gelatin, maltodextrin, and shellac.

The amount of coating or encapsulating material on the flavored core controls the length of time for its release from chewy candy. Generally, the higher the level of coating and the lower the amount of active a flavoring agent, the slower the release during mastication. To obtain the delayed release of the flavoring agent in the core, the first layer should be a minimum of about 20% by weight of the core. Preferably, the first should be a minimum of about 30% by weight of the coated flavoring agent. Depending on the coating material, a higher or lower amount of coating material may be needed to give the desired release.

The core may be prepared by any suitable method. These techniques include, but are not limited to, spray drying, spray chilling, and coacervation. These techniques may be used individually in a single step process or in any combination in a multiple step process.

In spray drying, the flavoring agent is prepared by spraying a composition including a flavoring agent and a carrier such as an acacia gum (such as gum arabic or gum talha), maltodextrin, or gelatin. In one embodiment, it may be prepared by the spray drying technique discloses in U.S. Published Application 2004/0022895, the contents of which are hereby incorporated by reference herein.

The mixture used for the spray drying will generally comprise about 0% to about 60% water, about 32% to about 10% carrier ingredients and about 5% to about 12% flavor prior to being spray dried. To prepare flavors for spray drying, the carrier is hydrated to give a 40-50% solution. In one embodiment, the flavor is added to a mix of acacia gum and homogenized. The ratio of solids to flavor material is preferably about 4:1. The flavor/carrier mixture is fed into a Niro Atomizer Spray Dryer, where it is atomized through a spinning wheel. Hot air flowing in co-current direction contacts the atomized particles and evaporates the water. This produces dried particles having a matrix containing small droplets of flavor to be used as the core material.

The core may also be solid flavor, such as a solid crystal sweetener or physiological cooling agent. In another embodiment, a flavoring agent may be absorbed onto another component which is porous and become entrapped in the matrix of the porous component. Common materials used for absorbing a flavoring agent include, but are not limited to, silicas, silicates, cellulose, pharmasorb clay, spongelike beads or microbeads, amorphous carbonates and hydroxides, including aluminum and calcium lakes. Cyclodextrin is another material than be used to fix a liquid flavor.

Depending on the type of absorbent materials and how it is prepared, the amount of flavoring agent that can be loaded onto the absorbent will vary. Generally materials like polymers or spongelike beads or microbeads, amorphous sugars and alditols and amorphous carbonates and hydroxides absorb about 10% to about 40% of the weight of the absorbent. Other materials like silicas and pharmasorb clays may be able to absorb about 20% to about 80% of the weight of the absorbent.

The general procedure for absorbing a flavoring agent onto the absorbent is as follows. An absorbent like fumed silica powder can be mixed in a powder blender and an aqueous solution of a flavoring agent can be sprayed onto the powder as mixing continues. The aqueous solution can be about 1 to 2% solids, and higher solid levels to 15-30% may be used if temperatures up to 90° are used. Generally water is the solvent, but other solvents like alcohol could also be used if approved for use in food. As the powder mixes, the liquid is sprayed onto the powder. Spraying is stopped before the mix becomes damp. The still free-flowing powder is removed from the mixer and dried to remove the water or other solvent, and is then ground to a specific particle size.

In one embodiment, the encapsulated particle is between about 100 microns and about 300 microns in diameter. The encapsulated particles contain about 10% to about 50% available flavoring agent.

The core is preferably encapsulated using fluid bed technology. In a fluid bed coater, the solid core particles are suspended in a stream of air. A liquid is sprayed into the fluidized particles, coating the particles. Coating levels range from 5% to 50%, depending on the substrate's particle size and the degree of coating desired. In the present invention, a bottom spray or Wurster coater is preferably used. This type of coater is known in the art. The Wurster coater includes a generally cylindrical coating chamber surrounding a separate cylinder in the core, known as a partition. A nozzle is partitioned in the core of a plate under the partition to spray a liquid upwardly through the partition. Air flow is directed through the partition, transporting the substrate past the nozzle which sprays concurrently into the fluidized material.

The present invention also provides a method of producing a candy product with a flavor delivery system. A core comprising a first flavoring agent is provided as described above. The core is coated in a fluid bed coater with a first layer. The first layer may be a hydrophobic layer or a hydrophilic layer. The first layer is preferably about 20% to about 50% by weight of the substrate, most preferably about 30% by weight. The first layer is then coated with a second layer comprising a second flavoring agent. The second layer may be a hydrophobic layer or a hydrophilic layer. The second layer is preferably about 20% to about 50% by weight of the substrate, most preferably about 30% by weight. The two layer coated core forms an encapsulated particle.

The encapsulated particle is then mixed with a base material to form a candy composition. The candy composition includes flavoring, with at least a portion of the flavoring supplied by the encapsulated particles. In addition to the encapsulated particles, liquid flavoring may also be added to the candy product. The level of encapsulated particles in the candy should be between about 0.1% and about 10%, preferably between about 0.3% and about 5%. Higher levels of encapsulated particles may be needed if the flavoring agent is encapsulated with multiple layers. In some cases, no liquid flavor is added to the candy, but various encapsulated particles are used to give a first wave of flavor, and various other encapsulated particles are added to give a second wave of flavor. The level of flavoring agent in the candy may be about 0.02% to about 1% by weight of the candy composition. The candy composition is then formed into a candy product.

The encapsulated flavor particles of the present invention may be used in any sort of candy product. It is particularly preferred for use in a chewy confectionery product. Examples of chewy confections include jellies, gummies, caramels, nougats, and taffies. Within these groups are confections with a wide variety of shapes, flavors, textures, and sizes. Jelly candy products include jellybeans, gummy bears, and licorice sticks. These products have a unique firm yet springy texture. Caramels are emulsions of fat droplets in a syrup of sugars and hydrated milk proteins. Nougats are nongrained, firm, chewy confections and obtain their structure from minute air cells, which give them a light texture. Taffies are also aerated, usually by a pulling machine, to produce a confection with a high degree of chewiness.

In general, a candy composition typically comprises a mixture of base materials, thickeners, colorants and flavors. The base material may be a sugar or a polyol. Among the sugars that may be used are sucrose, dextrose, lactose, maltose and other common sugars. In addition, base materials may include non-sugar bulking agents. Among these are polyols such as sorbitol, maltitol, mannitol, xylitol, hydrogenated isomaltalose, lactitol, erythritol and combinations thereof. High intensity sweeteners such as acesulfame K, aspartame, alitame, sucralose, glycyrrhizin, saccharin and cyclamates may also be included with the base materials. The candy composition may also include a sugarless sweetener. Sugarless sweeteners include components with sweetening characteristics but which are devoid of the commonly known sugars and comprise, but are not limited to, sugar alcohols such as sorbitol, mannitol, xylitol, hydrogenated starch hydrolyzates, maltitol and the like, alone or in any combination.

For the candy composition to give a long chew, it should include a material that would create a candy product that is tough, elastic, chewy, and of reduced solubility in water. Such materials include pectin, gelatin, cellulose gum, colloid gum (such as xanthan, carageneenan, or locust bean), substituted or crosslinked starches and/or other such long chain materials.

Thickeners include corn syrup, gelatin, pectin, and other common thickeners and are added in amounts that achieve the desired organoleptic effect. In one embodiment of the present invention, the candy product is a chewy candy product. The chewy candy product utilized in the practice of the present invention comprises sugar, corn syrup, fat and optionally, gelatin, which provide the desired chewy texture. Preferably, the chewy candy product comprises gelatin in the amount of about 1% to about 2% and fat in an amount of about 4% to about 10% by weight of the candy product. In another embodiment of the present invention, the candy product is a gummy candy product. The gummy candy product utilized in the practice of the present invention comprises sugar, corn syrup, gelatin and optionally, pectin, which provide the desired gummy texture. Preferably, the gummy candy product comprises gelatin in the amount of about 4% to about 8% and pectin in the amount of about 0.5% to about 1% by weight of the candy product. In an alternate embodiment of the present invention, the candy product comprises a soft chewy or a soft gummy candy product. The soft chewy gummy candy product comprises sugar, corn syrup and pectin, with pectin preferably in the amount of about 0.5% to about 2%, and more preferably about 2% by weight of the candy product, to achieve the desired soft chewy gummy texture. In yet another alternate embodiment, the candy product comprises a pressed chewy product. The pressed chewy candy product comprises sugar, corn syrup and fat, which provide the desired chewy texture. Preferably, the pressed chewy candy product comprises sugar in the amount of about 50% to about 60%, corn syrup in the amount of about 30% to about 40% and fat in the amount of about 1% to about 5% by weight of the candy product.

Pressed candy products or pressed chewy candy products may also include binders and lubricants. Binders that are commonly used are natural gums and hydrocolloids such as gum arabic, guar gum, agar, alginates, gum tragacanth, gelatin, corn syrups, modified starches, maltodextrins and optionally agglomerated dextrose. Most commonly used binders are gelatin, gum arabic or corn syrups. When non-sugar polyols such as sorbitol are used as the base material, binders are not needed for binding since many of these polyols are easily compressed to form candy products. In some cases polyols such as sorbitol may also act as a binder and may be combined with sugar to form the base materials for the compressed chewy candy product.

Lubricants may be used to give good release from the press tooling or die and punches. A variety of lubricants or non-stick agents may be used in a pressed chewy candy product to act as release agents. Some of these are starch, acetylated monoglycerides, waxes, lecithins, emulsifiers, and mono-, di-, tristearates. The most common of these lubricants are magnesium or calcium stearate and stearic acid. Solid lubricants may be added to the candy product composition to help form the candy product and allow for its release. Lubricants usually comprise about 0.5% to about 2% of the candy product. In some instances, low levels of flow agents such as silicon dioxide are added to the pressed chewy candy product composition to help the flow of the mixture into the press tooling.

Colors and other additives are also contemplated for use in the candy products of this invention.

### EXAMPLES

Several non-limiting examples of a candy product including encapsulated particles are described below. Encapsulated flavor particles comprising flavoring agents are prepared in a fluid bed coater as described above.

### Example 1

### Chewy Candy Product

TABLE 1
CHEWY CANDY PRODUCT

| Ingredients | g | % |
|---|---|---|
| Sugar | 768 | 32.08% |
| Corn Syrup 42 DE | 1120 | 46.78% |
| Water | 240 | 10.03% |
| Palm Kernel Oil | 147 | 6.14% |
| Gelatin, 250 bloom | 43.75 | 1.83% |
| Citric Acid | 25 | 1.04% |
| Malic acid | 7 | 0.29% |
| Encapsulated flavor particles | 32.75 | 1.37% |
| Monoglyceride | 4 | 0.17% |
| Lecithin | 4 | 0.17% |
| Colorant | 2.5 | 0.10% |
| Total (all) | 2394 | 100.0% |

Chewy Candy Product Processing Instructions

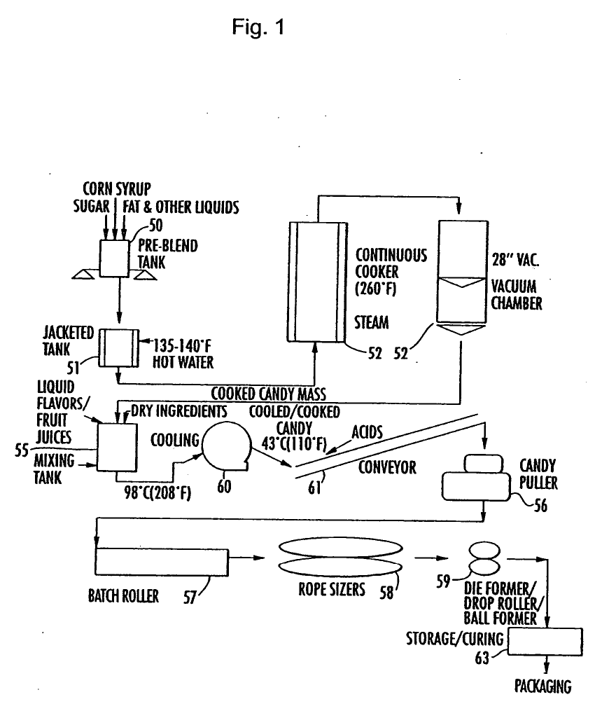

The chewy candy products of Example 1 are prepared as follows, using the equipment schematic shown in FIG. 1. The gelatin is dissolved in water and added to a mixer 55. Next, a syrup is made in a vacuum cooking system 52 by continuously mixing and cooking sugar, water, and the corn syrup to a temperature of about 250° F.-275° F. As shown in FIG. 1, the sugar, corn syrup and other liquids are added to pre-blend tank 50, cooked in a jacketed mixing kettle 51 with an agitator to a temperature of about 125° F.-150° F. and cooked to a final temperature of about 250° F.-275° F. in a vacuum cooking system 52. This syrup is added to the dissolved gelatin in the mixer 55 and is blended until the mixture thickens (for about 3 minutes). The mixture is then blended at high speed until it is aerated (for about 2 minutes). Next, the mixer speed is lowered and the remaining ingredients, including the encapsulated flavor particles, are added to form a paste, which is mixed until homogenous (for about 2 minutes). The homogenous mixture is pumped out of the mixer by pump 60 and conveyed along conveyor 61.

The chewy candy products are formed by using a puller unit 56, a batch roller 57, rope sizers 58, and/or a die former (drop roller or ball former) 59 as shown in FIG. 1. The formed chewy candy products may be stored or wrapped as a finished product.

### Example 2

### Gummy Candy Product

TABLE 2
GUMMY CANDY PRODUCT

| Ingredients | g | % |
|---|---|---|
| Corn Syrup (High Maltose) 42 DE | 150 | 27.82% |
| Sugar | 129 | 23.92% |
| Water | 192 | 35.6% |
| Sorbitol | 29.7 | 5.51% |
| Gelatin 200 bloom | 27 | 5.01% |
| Apple Extract Pectin | 2.7 | 0.50% |
| Citric Acid | 6 | 1.11% |
| Encapsulated flavor particles | 2.8 | 0.52% |
| Total (all) | 539.2 | 100.0% |

Gummy Candy Product Processing Instructions

The gummy candy product of Example 2 is prepared as follows. A syrup is prepared by cooking the corn syrup, sugar, 80 grams of the water and 27 grams of the sorbitol to a temperature of about 240° F. This syrup is cooled to a temperature of about 190° F. Meanwhile, 70 grams of water is used to dissolve the gelatin and 30 grams of water is mixed with the pectin and 2.7 grams of sorbitol. These solutions are combined to form a second mixture. This second mixture is added slowly to the cooled syrup and mixed until a homogenous mixture is obtained. Finally, the citric acid and encapsulated flavorings are added and stirred until homogenous. The resultant gummy mass is poured into starch molds, allowed to set overnight (about 24 hours) and then de-molded.

### Example 3

### Soft Chewy Gummy Candy Product

TABLE 3
SOFT CHEWY GUMMY CANDY PRODUCT

| Ingredients | % |
|---|---|
| Sugar | 42% |
| Water | 13% |
| Corn Syrup 43 DE | 40% |
| Pectin | 2% |
| Citric Acid | 1% |
| Sodium Citrate | 0.5% |
| Encapsulated flavor particles | 1.5% |
| Total (all) | 100.0% |

Soft Chewy Gummy Product Processing Instructions

The soft chewy gummy candy products of Example 3 are prepared as follows. A syrup is prepared by cooking the corn syrup, sugar and water to a temperature of about 240° F. This syrup is cooled to a temperature of about 190° F. Meanwhile, water and pectin are mixed. These solutions are combined and added to form a second mixture. This second mixture is added slowly to the cooled syrup and mixed until a homogenous mixture is obtained. Finally, the citric acid, sodium citrate and encapsulated particles are added and stirred until homogenous.

The soft chewy gummy candy products are formed using starch molds. The gummy candy products are allowed to set and are subsequently de-molded.

### Example 4

### Pressed Chewy Candy Product

TABLE 4
PRESSED CHEWY CANDY PRODUCT

| Ingredients | % |
|---|---|
| Powder (lumpy) Mixture comprising: | 84.70% |
| Sugar (55.13%) | |
| Corn Syrup 39 DE at 45 Be′ | |
| (41.35%) | |
| Fully Hydrogenated | |
| Cottonseed Oil (1.76%) | |
| Partially Hydrogenated | |
| Vegetable Oil (1.76%) | |
| Agglomerated Dextrose | 10.16% |
| Magnesium Stearate | 0.94% |
| Silicon Dioxide | 0.25% |
| Encapsulated flavor particles | 3.95% |
| Total (all) | 100.0% |

Pressed Chewy Candy Product Processing Instructions

The pressed chewy candy product of Example 4 is prepared as follows. A powder mixture is prepared by adding 55.13% sugar, 41.35% corn syrup, 1.76% fully hydrogenated cottonseed oil and 1.76% partially hydrogenated vegetable oil in a plough-type shear mixer and heating the mixer to about 270° F. When the final product temperature in the mixer is about 190° F., the mixture is removed, cooled and ground. After grinding, the powder mixture is added to a dry powder blender and the remaining ingredients are added. The pressed chewy candy products are formed by pressing the powder blended mixture into tablets.

### Example 5

### Sugarless Chewy Candy Product

TABLE 5
SUGARLESS CHEWY CANDY PRODUCT

| Ingredients | g | % |
|---|---|---|
| Maltitol | 768 | 32.08% |
| Maltitol Syrup | 1120 | 46.78% |
| Water | 240 | 10.03% |
| Palm Kernel Oil | 147 | 6.14% |
| Gelatin, 250 bloom | 43.75 | 1.83% |
| Citric Acid | 25 | 1.04% |
| Malic acid | 7 | 0.29% |
| Encapsulated flavor particles | 32.75 | 1.37% |
| Monoglyceride | 4 | 0.17% |
| Lecithin | 4 | 0.17% |
| Colorant | 2.5 | 0.10% |
| Total (all) | 2394 | 100.0% |

Sugarless Chewy Candy Product Processing Instructions

The sugarless chewy candy products of Example 5 are prepared as follows, using the equipment schematic shown in FIG. 1. The gelatin is dissolved in water and added to a mixer 55. Next, a syrup is made in a vacuum cooking system 52 by continuously mixing and cooking maltitol, water, and the maltitol syrup to a temperature of about 250° F.-275° F. As shown in FIG. 1, the maltitol, maltitol syrup and other liquids are added to pre-blend tank 50, cooked in a jacketed mixing kettle 51 with an agitator to a temperature of about 125° F.-150° F. and cooked to a final temperature of about 250° F.-275° F. in a vacuum cooking system 52. This syrup is added to the dissolved gelatin in the mixer 55 and is blended until the mixture thickens (for about 3 minutes). The mixture is then blended at high speed until it is aerated (for about 2 minutes). Next, the mixer speed is lowered and the remaining ingredients, including the encapsulated flavor particles, are added to form a paste, which is mixed until homogenous (for about 2 minutes). The homogenous mixture is pumped out of the mixer by pump 60 and conveyed along conveyor 61.

The sugarless chewy candy products are formed by using a puller unit 56, a batch roller 57, rope sizers 58, and/or a die former (drop roller or ball former) 59 as shown in FIG. 1. The formed chewy candy products may be stored in storage 63 or wrapped as a finished product.

### Example 6

### Sugarless Gummy Candy Product

TABLE 6
SUGARLESS GUMMY CANDY PRODUCT

| Ingredients | g | % |
|---|---|---|
| Maltitol Syrup | 150 | 27.82% |
| Maltitol | 129 | 23.92% |
| Water | 192 | 35.6% |
| Sorbitol | 29.7 | 5.51% |
| Gelatin 200 bloom | 27 | 5.01% |
| Apple Extract Pectin | 2.7 | 0.50% |
| Citric Acid | 6 | 1.11% |
| Encapsulated flavor particles | 2.8 | 0.52% |
| Total (all) | 539.2 | 100.0% |

Sugarless Gummy Candy Product Processing Instructions

The sugarless gummy candy product of Example 6 is prepared as follows. A syrup is prepared by cooking the maltitol syrup, maltitol, 92 grams of the water and 27 grams of the sorbitol to a temperature of about 240° F. This syrup is cooled to a temperature of about 190° F. Meanwhile, 70 grams of water is used to dissolve the gelatin and 30 grams of water is mixed with the pectin and 2.7 grams of sorbitol. These solutions are combined and to form a second mixture. This second mixture is added slowly to the cooled syrup and mixed until a homogenous mixture is obtained. Finally, the citric acid and encapsulated flavorings are added and stirred until homogenous. The resultant gummy mass is poured into starch molds, allowed to set overnight (about 24 hours) and then de-molded.

### Example 7

### Sugarless Soft Chewy Gummy Candy Product

TABLE 7
SUGARLESS SOFT CHEWY GUMMY CANDY PRODUCT

| Ingredients | % |
|---|---|
| Maltitol | 42% |
| Water | 13% |
| Maltitol Syrup | 40% |
| Pectin | 2% |
| Citric Acid | 1% |
| Sodium Citrate | 0.5% |
| Encapsulated flavor particles | 1.5% |
| Total (all) | 100.0% |

Sugarless Soft Chewy Gummy Candy Product Processing Instructions

The sugarless soft chewy gummy candy products of Example 7 are prepared as follows. A syrup is prepared by cooking the maltitol syrup, maltitol and water to a temperature of about 240° F. This syrup is cooled to a temperature of about 190° F. Meanwhile, water and pectin are mixed. These solutions are combined to form a second mixture. This second mixture is added slowly to the cooled syrup and mixed until a homogenous mixture is obtained. Finally, the citric acid, sodium citrate and the encapsulated particles are added and stirred until homogenous.

The sugarless soft chewy gummy candy products are formed using starch molds. The gummy candy products are allowed to set and are subsequently de-molded.

### Example 8

### Sugarless Pressed Chewy Candy Product

TABLE 8
SUGARLESS PRESSED CHEWY CANDY PRODUCT

| Ingredients | % |
|---|---|
| Powder (lumpy) Mixture | 84.70% |
| comprising: | |
| Maltitol (55.13%) | |
| Maltitol Syrup | |
| (41.35%) | |
| Fully Hydrogenated | |
| Cottonseed Oil (1.76%) | |
| Partially Hydrogenated | |
| Vegetable Oil (1.76%) | |
| Agglomerated Dextrose | 10.16% |
| Magnesium Stearate | 0.94% |
| Silicon Dioxide | 0.25% |
| Encapsulated flavor particles | 3.95% |
| Total (all) | 100.0% |

Sugarless Pressed Chewy Candy Product Processing Instructions

The sugarless pressed chewy candy product of Example 8 is prepared as follows. A powder mixture is prepared by adding 55.13% maltitol, 41.35% maltitol syrup, 1.76% fully hydrogenated cottonseed oil and 1.76% partially hydrogenated vegetable oil in a plough-type shear mixer and heating the mixer to about 270° F. When the final product temperature in the mixer is about 190° F., the mixture is removed, cooled and ground. After grinding, the powder mixture is added to a dry powder blender and the remaining ingredients are added. The pressed chewy candy products are formed by pressing the powder blended mixture into tablets.

### Example 9

### Coated Jelly Candy Product

TABLE 8

| | |
|---|---|
| Ingredients | % |

CENTER

| | |
|---|---|
| Cooked Polyol mixture | 66.91% |
| Gelatin solution | 46.47% |
| Citric solution | 2.02% |
| Aspartame | 0.07% |
| Color solution | 0.11% |
| Encapsulated flavor particles | 1.97% |
| Total before cure | 117.55% |
| Moisture loss during cure | (17.55%) |
| Total | 100.0% |

COATING

| | |
|---|---|
| Isomalt syrup | 66.00% |
| Isomalt powder | 25.10% |
| Powdered flavor blend | 8.90% |
| Total | 100.00% |

Coated Jelly Candy Product Processing Instructions

A cooked polyol mixture is made by mixing 59.74% maltitol syrup, 40.22% of a 70% sorbitol solution and 0.04% acesulfame K sweetener. The polyol mixture is cooked to remove about 20% of the water. A 37% aqueous gelatin solution is prepared and a 50% citric acid solution is prepared. The cooked polyol mixture, gelatin solution, and acid solution are mixed with aspartame, color and encapsulated flavor and allowed to cure and set up to a gel.

The coating includes isomalt syrup, isomalt powder, and a powdered flavor blend. The isomalt syrup is a 66% aqueous solution of 97.03% powder isomalt, 2.96% gum arabic, and 0.01% color. The powdered flavor blend is a dry blend of 69.0% isomalt powder, 30.0% encapsulated flavor particles, and 1.00% high intensity sweeteners. The center is then coated to give a product with a 77.65% center and 22.35% coating. As the isomalt syrup is applied to the center, dry powder isomalt powder and powder flavor blend is applied as a dry charge to aid in coating and drying along with air drying.

It should be appreciated that the methods and compositions of the present invention are capable of being incorporated in the form of a variety of embodiments, only a few of which have been illustrated and described above. The invention may be embodied in other forms without departing from its spirit or essential characteristics. It will be appreciated that the addition of some other ingredients, process steps, materials or components not specifically included will have an adverse impact on the present invention. The best mode of the invention may therefore exclude ingredients, process steps, materials or components other than those listed above for inclusion or use in the invention. However, the described embodiments are to be considered in all respects only as illustrative and not restrictive, and the scope of the invention is, therefore, indicated by the appended claims rather than by the foregoing description. All changes which come within the meaning and range of equivalency of the claims are to be embraced within their scope.

What is claimed is:

1. A method of producing a candy product, comprising
a) providing a core comprising a first flavoring agent;
b) coating the core with a first layer to form a first coated product, wherein the first layer is selected from a hydrophobic layer and a hydrophilic layer;
c) coating the first coated product with a second layer comprising a second flavoring agent to form an encapsulated particle, wherein the second layer is selected from a hydrophobic layer and a hydrophilic layer;
d) mixing the encapsulated particle with a base material to form a candy composition; and
e) forming the candy composition into a candy product.

2. The method of claim 1 wherein the core is coated with the first layer in a fluid bed coater.

3. The method of claim 1 wherein the first coated product is coated with the second layer in a fluid bed coater.

4. The method of claim 1 wherein the first layer is a hydrophobic layer.

5. The method of claim 1 wherein the second layer is a hydrophilic layer.

6. The method of claim 1 wherein, when chewed by a consumer, the candy product provides a first wave of flavor from the second flavoring agent followed by a second wave of flavor from the first flavoring agent.

7. The method of claim 1 wherein the first flavoring agent is selected from the group consisting of flavors, sweeteners, physiological cooling agents, and mixtures thereof.

8. The method of claim 1 wherein the second flavoring agent is selected from the group consisting of flavors, sweeteners, physiological cooling agents, and mixtures thereof.

9. The method of claim 1 wherein the core is prepared by spray drying.

10. The method of claim 1 wherein the core is between about 10 microns and about 100 microns in diameter.

11. The method of claim 1 wherein the core is between about 0.2 microns and about 10 microns in diameter

12. The method of claim 1 wherein the encapsulated particle is between about 100 microns and about 300 microns in diameter

13. The method of claim 1 wherein the first layer comprises a material selected from the group consisting of zein, wax, and polyvinyl acetate.

14. The method of claim 1 wherein the second layer comprises a material selected from the group consisting of acacia gum, gelatin, and shellac.

15. A candy product comprising a plurality of encapsulated particles, each encapsulated particle comprising:
a) a core comprising a first flavoring agent;
b) a first layer surrounding the core and comprising a hydrophobic material; and
c) a second layer surrounding the first layer and comprising a second flavoring agent and a hydrophilic material;
wherein the candy provides a first wave of flavor from the second flavoring agent followed by a second wave of flavor from the first flavoring agent.

16. The candy product of claim 15 wherein the encapsulated particles are between about 100 microns and about 300 microns in diameter

17. The candy product of claim 15 wherein the first layer of each of the encapsulated particles comprises a material selected from the group consisting of zein, wax, and polyvinyl acetate.

18. The candy product of claim 15 wherein the second layer of each of the encapsulated particles comprises a material selected from the group consisting of acacia gum, gelatin, and shellac.

19. A candy product comprising a plurality of a first type of encapsulated particles and a plurality of a second type of encapsulated particles, wherein each of the first type of encapsulated particle comprises:
a core comprising a first flavoring agent; and
a layer surrounding the core and comprising a first hydrophobic material; and wherein each of the second type of encapsulated particle comprises:
a core comprising a second flavoring agent; and
a layer surrounding the core and comprising a second hydrophobic material;
wherein the first and second hydrophobic materials provide different release times for the first flavoring agent and the second flavoring agent.

20. The candy product of claim 19 wherein the first and second hydrophobic materials are the same.

21. The candy product of claim 19 wherein the first and second hydrophobic materials are selected from the group consisting of zein, wax, and polyvinyl acetate.

22. The candy product of claim 19 wherein the layers in the first and second hydrophobic types of encapsulated particles are of different thicknesses.

23. The candy product of claim 19 wherein the release time of the first type of encapsulated particles is between about 1 minute and about 8 minutes.

24. The candy product of claim 19 wherein the release time of the first type of encapsulated particles is about 3 minutes.
